(19) United States
(12) Patent Application Publication
(10) Pub. No.: US 2015/0325207 A1
(43) Pub. Date: Nov. 12, 2015

(54) MOBILE TERMINAL DEVICE, AND DISPLAY CONTROL METHOD

(71) Applicant: FUJITSU LIMITED, Kawasaki-shi (JP)

(72) Inventor: Masao Hara, Kunitachi (JP)

(21) Appl. No.: 14/691,038

(22) Filed: Apr. 20, 2015

(30) Foreign Application Priority Data
May 7, 2014 (JP) 2014-096349

(51) Int. Cl. G09G 5/10; G09G 5/18; G06F 3/01; G09G 5/00; G06F 3/041

(52) U.S. Cl. CPC G09G 5/10; G09G 5/003; G06F 3/0416; G06F 3/017; G09G 5/18; G09G 2360/144

(57) ABSTRACT

A mobile terminal device includes: a detecting unit that detects an input to a predetermined area that is set in a display operation unit that includes a touch panel; a determining unit that determines whether an illuminance sensor is affected by the input to the predetermined area; and a restricting unit that restricts automatic light control of the display operation unit when the determining unit determines that the illuminance sensor is affected.

### CROSS-REFERENCE TO RELATED APPLICATION

This application is based upon and claims the benefit of priority of the prior Japanese Patent Application No. 2014-096349, filed on May 7, 2014, the entire contents of which are incorporated herein by reference.

### FIELD

The embodiments discussed herein are related to a mobile terminal device, a display control method, and a display control program.

### BACKGROUND

Conventionally, in mobile terminal devices, such as smart phones or the like, brightness of displayed screens is usually automatically controlled by detecting, using illuminance sensors, brightness of the surroundings and by adjusting a backlight of displaying units. Furthermore, for applications executed in smart phones, there are known applications for screens that are vertically used and there are known applications for screens that are horizontally used. The application for a screen that is horizontally used sometimes has a user interface in which a user holds a smart phone by both hands and an operation is performed by, for example, the user's thumbs. Furthermore, even for the application for a screen that is vertically used, if, for example, a map or the like is displayed, a user sometimes holds a smart phone upside down.

Patent Document 1: Japanese Laid-open Patent Publication No. 2007-079113

Patent Document 2: Japanese Laid-open Patent Publication No. 2005-107766

Patent Document 3: Japanese Laid-open Patent Publication No. 2007-163557

However, if a smart phone is used in a state in which a screen is horizontally used or used upside down, the user's finger may sometimes temporarily cover an illuminance sensor. The smart phone controls a brightness of a displayed screen by using an illuminance sensor; however, if an input of the light from outside to the illuminance sensor is changed due to the illuminance sensor being covered by a user's finger, in each case, the brightness of the displayed screen is controlled. Consequently, in the smart phone, due to an excessive automatic light control operation, the displayed screen blinks and flickers.

### SUMMARY

According to an aspect of an embodiment, a mobile terminal device includes: a detecting unit that detects an input to a predetermined area that is set in a display operation unit that includes a touch panel; a determining unit that determines whether an illuminance sensor is affected by the input to the predetermined area; and a restricting unit that restricts automatic light control of the display operation unit when the determining unit determines that the illuminance sensor is affected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of the configuration of a mobile terminal device according to a first embodiment;

FIG. 2 is a schematic diagram illustrating an example of a startup app storing unit;

FIG. 3 is a schematic diagram illustrating an example of a coordinates storing unit;

FIG. 4 is a schematic diagram illustrating an example of a sampling of output values of an illuminance sensor;

FIG. 5 is a schematic diagram illustrating an example of the relationship between the direction of the mobile terminal device and a predetermined area;

FIGS. 6A and 6B are flowcharts illustrating an example of the flow of a process performed by the mobile terminal device according to the first embodiment;

FIG. 7 is a flowchart illustrating an example of the flow of a determination process;

FIG. 8 is a block diagram illustrating an example of the configuration of a mobile terminal device according to a second embodiment;

FIG. 9 is a flowchart illustrating an example of the flow of a process performed by the mobile terminal device according to the second embodiment; and

FIG. 10 is a block diagram illustrating an example of a computer that executes a display control program.

### DESCRIPTION OF EMBODIMENTS

Preferred embodiments of the present invention will be explained with reference to accompanying drawings. The disclosed technology is not limited to these embodiments. Furthermore, the embodiments can be used in any appropriate combination as long as processes do not conflict with each other.

### [a] First Embodiment

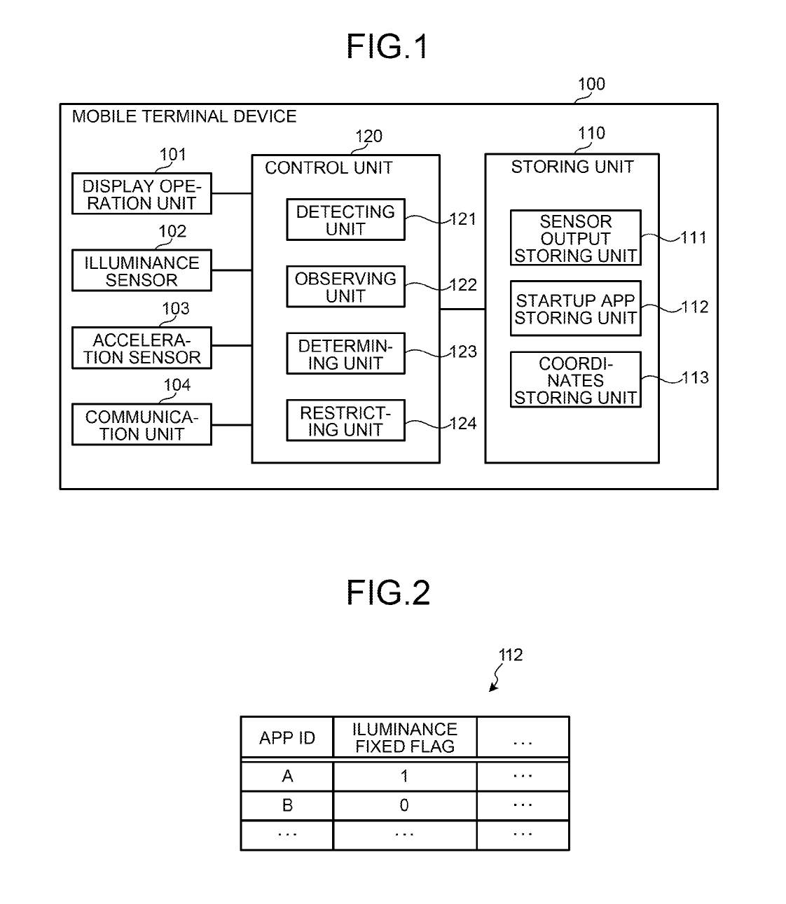

FIG. 1 is a block diagram illustrating an example of the configuration of a mobile terminal device according to a first embodiment. A mobile terminal device 100 illustrated in FIG. 1 includes a display operation unit 101, an illuminance sensor 102, an acceleration sensor 103, a communication unit 104, a storing unit 110, and a control unit 120. For example, a smart phone, a mobile phone, a personal handy phone system (PHS), and a personal digital assistant or a personal data assistance (PDA) can be used for the mobile terminal device 100.

The display operation unit 101 is a display device that is used to display various kinds of information and is an input device that is used to receive various operations from a user. For example, the display operation unit 101 is implemented as the display device by a liquid crystal display or the like. Furthermore, for example, the display operation unit 101 is implemented as the input device by a touch panel or the like. Namely, the display operation unit 101 is implemented by integrating the display device with the input device. The display operation unit 101 outputs the coordinates that are input by the user to the control unit 120. In a description below, it is assumed that the coordinates that are displayed on the display device are the same as the coordinates that are input by the input device.

The illuminance sensor 102 detects brightness in the vicinity of the mobile terminal device 100. The illuminance sensor 102 performs analog/digital (A/D) such that an output of, for example, a photodiode is converted to illuminance and then outputs the illuminance to the control unit 120 as an output value of the illuminance sensor 102. For example, if the power supply of the mobile terminal device 100 is turned on and an instruction to start detecting illuminance is received from the control unit 120, the illuminance sensor 102 starts to output the illuminance as output values to the control unit 120. The illuminance sensor 102 continues to output the output values to the control unit 120 until the illuminance sensor 102 receives, for example, an instruction to stop detecting the illuminance from the control unit 120. Furthermore, for the illuminance sensor 102, another type of photodetector, such as, a photoresistor or a phototransistor may also be used.

The acceleration sensor 103 detects the direction of the mobile terminal device 100 by detecting gravitational acceleration. An example of the acceleration sensor 103 that can be used includes an acceleration sensor that uses micro electro mechanical systems (MEMS) with, for example, a capacitance type, a piezoresistance type, a gas temperature distribution type, or the like. The acceleration sensor 103 outputs the detected acceleration as acceleration information to the control unit 120.

The communication unit 104 is implemented by a wireless communication module that can be used for, for example, a mobile phone line, a wireless local area network (LAN), or the like. Here, for example, the line of the 3.9^{th} generation (for example Long Term Evolution (LTE)), the 3^{rd} generation, or the 3.5^{th} generation can be used for the mobile phone line. The communication unit 104 a communication interface that is connected to, for example, the Internet via a wireless base station and that manages communication of various kinds of information.

The storing unit 110 is implemented by a semiconductor memory device, such as a random access memory (RAM), a flash memory, and the like, or implemented by a storage device, such as a hard disk, an optical disk, and the like. The storing unit 110 includes a sensor output storing unit 111, a startup app storing unit 112, and a coordinates storing unit 113. Furthermore, the storing unit 110 stores therein information that is used for a process performed in the control unit 120.

The sensor output storing unit 111 stores therein an output value of the illuminance sensor 102. The output value of the illuminance sensor 102 is input via the control unit 120. The sensor output storing unit 111 stores therein an output value of the illuminance sensor 102 when, for example, an application is started up by the control unit 120 or when, for example, an input is received by the display operation unit 101. Namely, the sensor output storing unit 111 stores therein, as a trigger, a start up of an application or an output value of the illuminance sensor 102 that is obtained when an operation is performed. In a description below, an application may sometimes be simply referred to as an “app”.

The startup app storing unit 112 stores therein, in associated manner, each application that was started up in the past and information indicating whether automatic light control is restricted. FIG. 2 is a schematic diagram illustrating an example of a startup app storing unit. As illustrated in FIG. 2, the startup app storing unit 112 includes items, such as the “app identification (ID)”, the “luminance fixed flag”, and the like.

The “app ID” identifies an application that was started up in the past. The “luminance fixed flag” indicates, for the application that was started up in the past, whether the automatic light control is restricted. For the “luminance fixed flag”, for example, “1” is set to the application in which the automatic light control is restricted by the control unit 120 and “0” is set to the application in which the automatic light control is not restricted by the control unit 120.

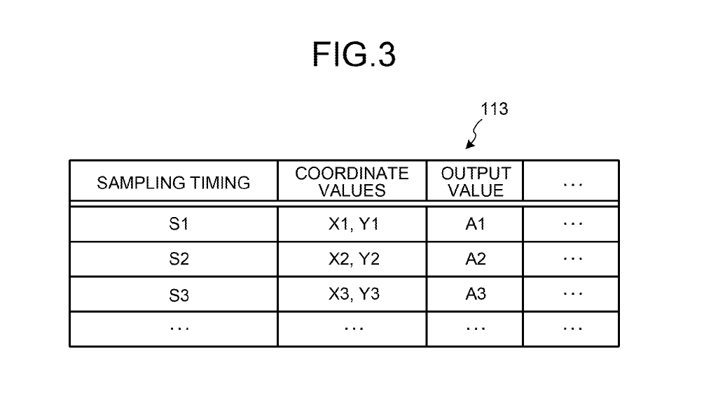

The coordinates storing unit 113 stores therein, in an associated manner, sampling timing in a predetermined sampling time period, the coordinate values that are input to the display operation unit 101 for each piece of the sampling timing, and an output value of the illuminance sensor 102. FIG. 3 is a schematic diagram illustrating an example of a coordinates storing unit. As illustrated in FIG. 3, the coordinates storing unit 113 includes therein items, such as the “sampling timing”, the “coordinate values”, the “output value”, and the like.

The “sampling timing” indicates the timing at which illuminance is sampled in a predetermined sampling time period. For example, one second may be set to the predetermined sampling time period. The “coordinate values” indicates, for example, the values of the coordinates on the display operation unit 101 that are input by a user's finger touching the touch panel of the display operation unit 101. The “output value” indicates an output value of the illuminance sensor 102 obtained at the sampling timing. Namely, the coordinates storing unit 113 stores therein, in an associated manner, the coordinate values and an output value of the illuminance sensor obtained at each sampling timing when an operation of, for example, swiping the display operation unit 101 is performed by a user's finger.

A description will be given here by referring back to FIG. 1. The control unit 120 is implemented by, for example, a central processing unit (CPU), a micro processing unit (MPU), or the like executing, in a RAM as a work area, the program that is stored in an inner storage device. Furthermore, the control unit 120 may also be implemented by an integrated circuit, such as an ASIC, an FPGA, or the like. The control unit 120 includes a detecting unit 121, an observing unit 122, a determining unit 123, and a restricting unit 124 and implements or executes the function or the operation of the information processing, which will be described below. The internal configuration of the control unit 120 is not limited to the configuration illustrated in FIG. 1. Another configuration may also be used as long as the information processing, which will be described later, is performed. Furthermore, the control unit 120 executes various applications.

The detecting unit 121 receives an output value that is input from the illuminance sensor 102. The detecting unit 121 stores, in the sensor output storing unit 111, the output value of the illuminance sensor 102 that was input. When an input of, for example, an output value of the illuminance sensor 102 is started, the detecting unit 121 stores, in the sensor output storing unit 111, the output value of the illuminance sensor 102 at the timing, used as a trigger, instructed by the determining unit 123, i.e., a startup or an operation of the application.

Furthermore, the detecting unit 121 receives an input of the coordinates as the coordinate values from the display operation unit 101. Furthermore, the detecting unit 121 samples the received input of the output values of the illuminance sensor 102. When the coordinate values are input, i.e., when the detecting unit 121 detects an input to the display operation unit 101, the detecting unit 121 stores, in the coordinates storing unit 113, data on the sampling that is performed by a predetermined number of times in a predetermined sampling time period that includes the immediately previous input sampling timing. In other words, the detecting unit 121 stores, in an associated manner in the coordinates storing unit 113, the output values of the illuminance sensor 102 and the coordinate values obtained at the predetermined number of times of the sampling timing in a predetermined sampling time period that includes the immediately previous sampling timing that is input to the display operation unit 101. Furthermore, the detecting unit 121 may also set a predetermined sampling time period that does not include the immediately previous sampling timing that is input to the display operation unit 101 in the predetermined sampling time period, i.e., may also set a predetermined sampling time period after an input to the display operation unit 101 is performed.

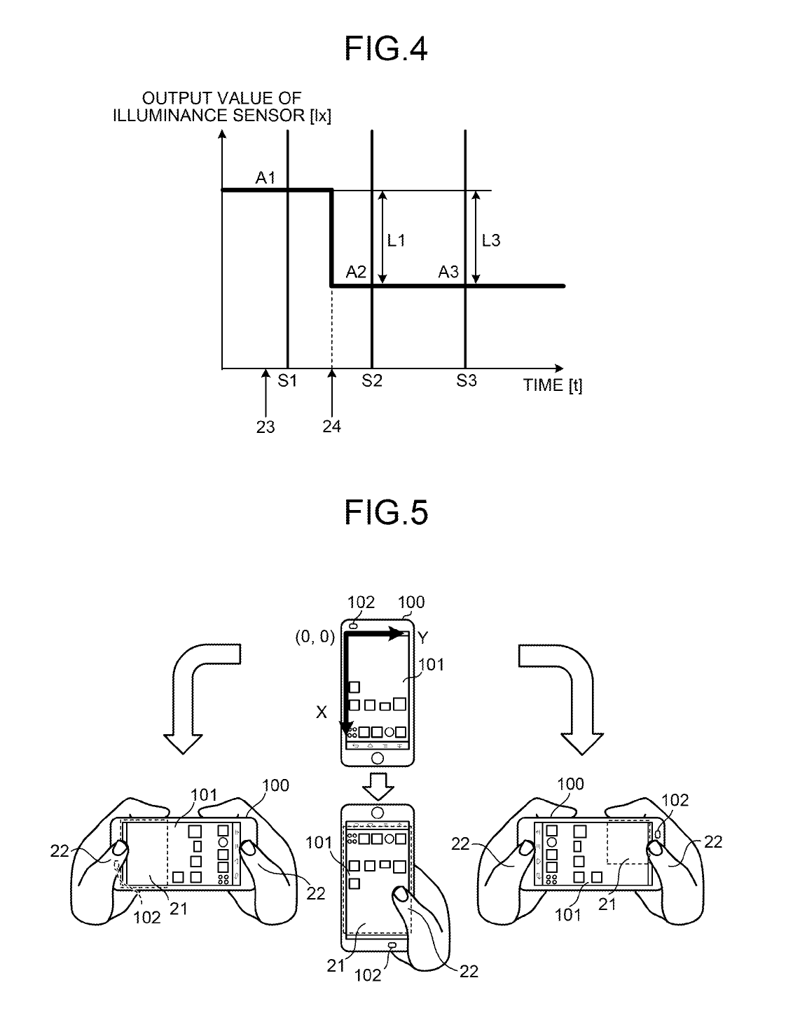

In the following, an example of the sampling will be described with reference to FIG. 4. FIG. 4 is a schematic diagram illustrating an example of a sampling of output values of an illuminance sensor. In the example illustrated in FIG. 4, the detecting unit 121 samples the output value of the illuminance sensor 102 three times, i.e., at sampling timing S1, S2, and S3. The detecting unit 121 associates the coordinate values that are input to the display operation unit 101 and that is obtained at the sampling timing S1, S2, and S3 with output values A1, A2, and A3, respectively, of the illuminance sensor 102 and stores the associated data in the coordinates storing unit 113.

Here, for example, it is assumed that the timing at which a user starts an input to the display operation unit 101 is timing 23 and the input performed by the user is continued until the elapse of the sampling timing S3. Furthermore, the example illustrated in FIG. 4 indicates that, at timing 24, the illuminance sensor 102 is covered by a user's finger. Consequently, the output value A2 of the illuminance sensor 102 at the sampling timing S2 is decreased by a difference L1 from the output value A1 of the illuminance sensor 102 at the sampling timing S1. Similarly, the output value A3 of the illuminance sensor 102 at the sampling timing S3 is decreased by a difference L3 from the output value A1 of the illuminance sensor 102 at the sampling timing S1. Furthermore, the example illustrated in FIG. 4 does not illustrate the immediately previous sampling timing at which the user starts an input to the display operation unit 101. Furthermore, in FIG. 4, because the difference L2 between the output values A2 and A3 is zero, this state is not illustrated.

Furthermore, for example, one second may be set to a predetermined sampling time period and this sampling time period may also be repeated until an input to the display operation unit 101 is continued. Furthermore, any number of times may be used for the number of predetermined times of sampling and, for example, three times may be set. Namely, the sampling of the output value of the illuminance sensor 102 is executed, for example, three times per second and the sampling is continued during the time period for which the user continues an input to the display operation unit 101.

When acceleration information is input from the acceleration sensor 103, the observing unit 122 observes the direction of the mobile terminal device 100 on the basis of the acceleration information. Namely, the observing unit 122 observes that the mobile terminal device 100 is, for example, in the positive direction, i.e., in a normal use direction, in which an illuminance sensor is located at an upper portion of a casing; in a lateral direction in which the mobile terminal device 100 is laterally rotated by substantially 90°; or in the reverse direction in which the mobile terminal device 100 is inverted by being rotated by substantially 180°.

Furthermore, the observing unit 122 sets a predetermined area of the display operation unit 101 in accordance with the direction of the mobile terminal device 100. FIG. 5 is a schematic diagram illustrating an example of the relationship between the direction of the mobile terminal device and a predetermined area. As illustrated in FIG. 5, if the mobile terminal device 100 is in the positive direction, the illuminance sensor 102 is located in the upper portion of the casing and a predetermined area is not set in the display operation unit 101. Furthermore, the display operation unit 101 indicates the coordinates by the X axis and the Y axis and uses the upper left corner of the mobile terminal device 100 when it is in the positive direction as the coordinates (0,0).

If the mobile terminal device 100 is rotated by, for example, substantially 90° in the right direction and is in the lateral direction, the observing unit 122 sets, as a predetermined area 21, the area in which the illuminance sensor 102 is possibly covered by a finger 22 of the user. In the example illustrated in FIG. 5, this state is indicated by the drawing on the right side illustrated in FIG. 5. Furthermore, if the mobile terminal device 100 is rotated by, for example, substantially 90° in the left direction and is in the lateral direction, the observing unit 122 sets, as a predetermined area 21, the area in which the illuminance sensor 102 is possibly covered by the finger 22 of the user. In the example illustrated in FIG. 5, this state is indicated by the drawing on the left side illustrated in FIG. 5. At this time, because the illuminance sensor 102 is located on the near side of the user, when compared with the case in which the mobile terminal device 100 is rotated by substantially 90° in the right direction and is in the lateral direction, the illuminance sensor 102 tends to be covered by the finger 22. Consequently, the predetermined area 21 that is obtained when the mobile terminal device 100 is rotated by substantially 90° in the left direction and is in the lateral direction becomes greater than that obtained when the mobile terminal device 100 is rotated by substantially 90° in the right direction and is in the lateral direction.

Furthermore, if the mobile terminal device 100 is rotated by, for example, substantially 180° and is upside down, for the area in which the illuminance sensor 102 is possibly covered by the finger 22 of the user, the observing unit 122 sets, for example, the entire of the display operation unit 101 to the predetermined area 21. In the example illustrated in FIG. 5, this state is indicated by the drawing in the lower portion of the center area illustrated in FIG. 5. At this time, because the illuminance sensor 102 is located in the lower portion of the casing, the illuminance sensor 102 tends to be covered by the finger 22 or the hand of the user. Namely, the observing unit 122 sets, in accordance with the direction of the mobile terminal device 100, the area that supposedly affects the illuminance sensor 102 as the predetermined area. The observing unit 122 outputs the set predetermined area to the determining unit 123.

The determining unit 123 determines whether the application that is started up by the control unit 120 is the initial startup. If the started up application is the initial startup, the determining unit 123 instructs the observing unit 122 to observe the direction of the mobile terminal device 100. If the started up application is not the initial startup, the determining unit 123 checks the flag that is associated with the application that was started up by the startup app storing unit 112. The determining unit 123 determines whether the flag that is associated with the application started up by the startup app storing unit 112 is “1”. If the flag that is associated with the application started up by the startup app storing unit 112 is “1”, the determining unit 123 stores the output value of the illuminance sensor 102 in the sensor output storing unit 111 and outputs restriction information that is used by the restricting unit 124 to restrict the automatic light control. If the flag that is associated with the application started up by the startup app storing unit 112 is not “1”, the determining unit 123 determines that the subject application is an application in which the automatic light control is not restricted and then ends the process.

Furthermore, if a predetermined area is input from the observing unit 122, the determining unit 123 instructs the detecting unit 121 to store the output value of the illuminance sensor 102 in the sensor output storing unit 111. Furthermore, if the predetermined area is input from the observing unit 122, the determining unit 123 determines whether an operation is input by a user to the display operation unit 101. If the operation has not been input to the display operation unit 101, the determining unit 123 waits for an operation to be input to the display operation unit 101. If an operation has been input to the display operation unit 101, the determining unit 123 determines, from among the coordinate values of the coordinates storing unit 113 stored by the detecting unit 121, one or more of the coordinate values are in a predetermined area that is input by the observing unit 122. In other words, the detecting unit 121 detects an input of the predetermined area that is set in the display operation unit 101 and then the determining unit 123 determines whether the detected input is within the predetermined area.

From among the coordinate values in the coordinates storing unit 113, one or more of the coordinate values are within the subject predetermined area, the determining unit 123 determines whether there is a case in which the output value of the coordinates storing unit 113 is less than the output value of the immediately previous sampling timing. If the output value of the coordinates storing unit 113 is less than the output value of the immediately previous sampling timing, the determining unit 123 creates determination information indicating that the illuminance sensor 102 is covered. Namely, in the example illustrated in FIG. 4, because the difference L1 occurs, it can be determined that the output value A2 is less than the output value A1 and the determining unit 123 creates determination information indicating that the illuminance sensor 102 is covered. If none of the coordinate values in the coordinates storing unit 113 are in the subject predetermined area and if the output value of the coordinates storing unit 113 is equal to or greater than the output value of the immediately previous sampling timing, the determining unit 123 creates determination information indicating that the illuminance sensor 102 is not covered.

If the determining unit 123 creates the determination information indicating the illuminance sensor 102 is covered, the determining unit 123 outputs restriction information that is used by the restricting unit 124 to restrict the automatic light control. If the determining unit 123 creates the determination information indicating that the illuminance sensor 102 is not covered, the determining unit 123 determines whether a record of the started up application is created in the startup app storing unit 112. If the determining unit 123 does not create the record of the started up application, the determining unit 123 creates the record of the started up application and sets the flag to “0”. If the determining unit 123 creates the record of the started up application, the determining unit 123 determines whether the started up application has been ended. If the started up application has not been ended, the determining unit 123 sets the flag associated with the started up application in the startup app storing unit 112 to “0” and then returns to an input standby state with respect to the display operation unit 101. If the started up application has been ended, the determining unit 123 ends the process.

In the restricting unit 124, restriction information is input from the determining unit 123. If the restricting unit 124 receives an input of the restriction information that is used to restrict the automatic light control, the restricting unit 124 restricts, on the basis of the output values of the sensor output storing unit 111, the automatic light control of the display operation unit 101. Namely, the restricting unit 124 restricts the automatic light control of the display operation unit 101 so as to maintain the luminance of the display operation unit 101 on the basis of the output value of the illuminance sensor 102 at the time of the start up of the application. When the restricting unit 124 restricts the automatic light control, the restricting unit 124 creates the record of the started up application in the startup app storing unit 112 and sets the flag to “1”.

When the restricting unit 124 sets the flag associated with the started up application in the startup app storing unit 112 to “1”, the restricting unit 124 determines whether the started up application has been ended. If the started up application has not been ended, the restricting unit 124 repeats the end determination. If the started up application has been ended, the restricting unit 124 releases the restriction of the automatic light control. Furthermore, for a case in which the started up application has not been ended but the state enters a background state in which no display is performed on the display operation unit 101, the restricting unit 124 also releases the restriction of the automatic light control. In this case, if the subject application enters a foreground state and is displayed on the display operation unit 101, the restricting unit 124 can resume the restriction of the automatic light control by referring to the subject flag in the startup app storing unit 112.

In the following, an operation of the mobile terminal device 100 according to the first embodiment will be described.

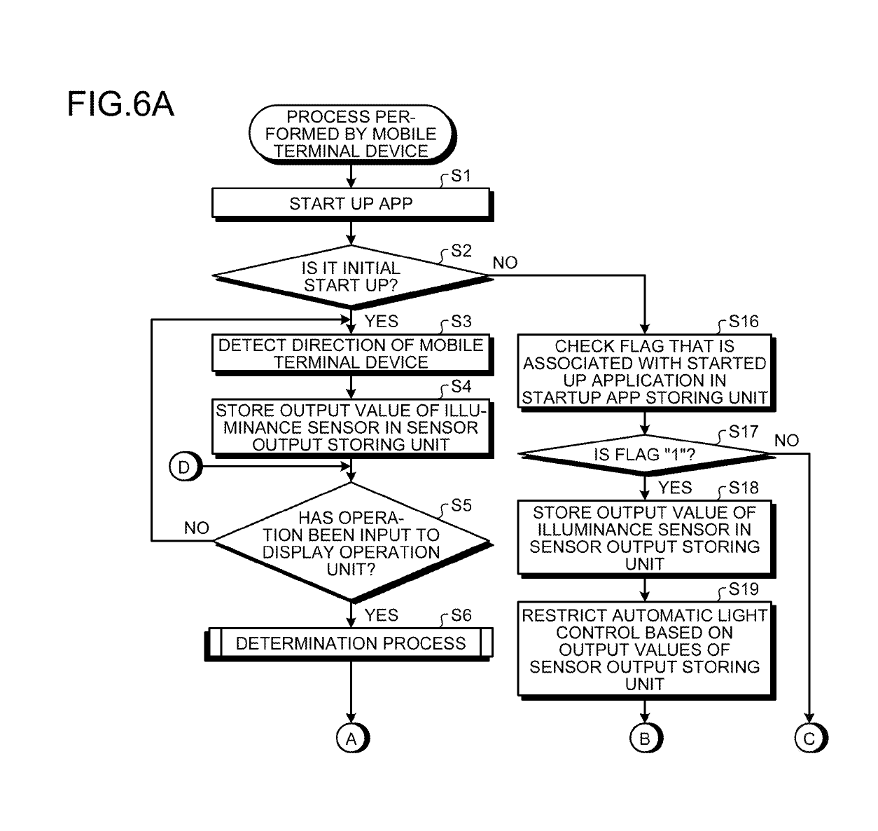

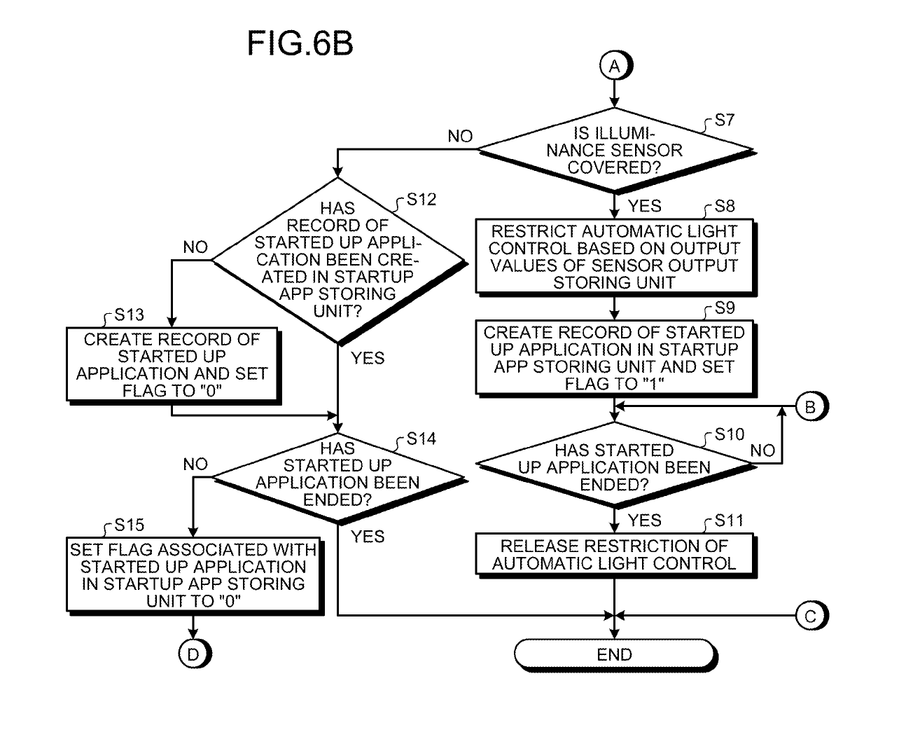

FIGS. 6A and 6B are flowcharts illustrating an example of the flow of a process performed by the mobile terminal device according to the first embodiment. The control unit 120 in the mobile terminal device 100 starts up the application (Step S1). The determining unit 123 determines whether the application that was started up by the control unit 120 is the initial startup (Step S2). If the application that was started up by the control unit 120 is the initial startup (Yes at Step S2), the determining unit 123 instructs the observing unit 122 to observe the direction of the mobile terminal device 100. The observing unit 122 observes the direction of the mobile terminal device 100 on the basis of the acceleration information (Step S3). The observing unit 122 sets a predetermined area in accordance with the direction of the mobile terminal device 100 and outputs the set predetermined area to the determining unit 123.

If the predetermined area is input from the observing unit 122, the determining unit 123 instructs the detecting unit 121 to store the output values of the illuminance sensor 102 in the sensor output storing unit 111. The detecting unit 121 stores, in the sensor output storing unit 111, the output value of the illuminance sensor 102 at the timing instructed by the determining unit 123 (Step S4). If the predetermined area is input from the observing unit 122, the determining unit 123 determines whether an operation has been input by a user to the display operation unit 101 (Step S5). If an operation has not been input by a user to the display operation unit 101 (No at Step S5), the determining unit 123 returns to Step S3 and waits for an operation to be input. If an operation has been input to the display operation unit 101 (Yes at Step S5), the determining unit 123 performs a determination process (Step S6).

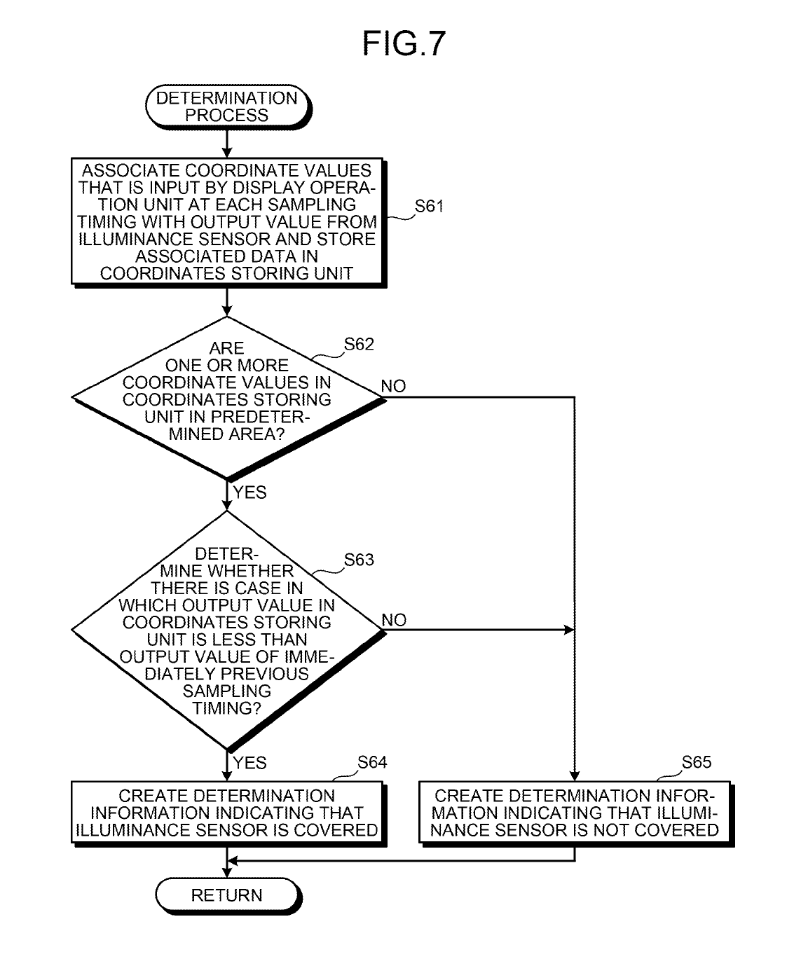

In the following, the determination process will be described with reference to FIG. 7. FIG. 7 is a flowchart illustrating an example of the flow of a determination process. The detecting unit 121 associates the coordinate values that are input by the display operation unit 101 at each sampling timing with the output values from the illuminance sensor 102 and stores the associated data in the coordinates storing unit 113 (Step S61). From among the coordinate values in the coordinates storing unit 113 stored by the detecting unit 121, the determining unit 123 determines whether one or more coordinate values are in the predetermined area that is input by the observing unit 122 (Step S62). If, from among the coordinate values in the coordinates storing unit 113, one or more coordinate values are in the subject predetermined area (Yes at Step S62), the determining unit 123 determines whether there is a case in which the subject output value in the coordinates storing unit 113 is less than the output value of the immediately previous sampling timing (Step S63). If the subject output value in the coordinates storing unit 113 is less than the output value of the immediately previous sampling timing (Yes at Step S63), the determining unit 123 creates the determination information indicating that the illuminance sensor 102 is covered (Step S64), ends the determination process, and returns to the previous process.

If none of the coordinate value from among the coordinate values in the coordinates storing unit 113 is in the subject predetermined area (No at Step S62), the determining unit 123 creates the determination information indicating that the illuminance sensor 102 is not covered (Step S65), ends the determination process, and returns to the previous process. Furthermore, if there is a case in which the output value of the coordinates storing unit 113 is equal to or greater than the immediately previous output value at the sampling timing (No at Step S63), the determining unit 123 similarly creates the determination information indicating that the illuminance sensor 102 is not covered (Step S65), ends the determination process, and returns to the previous process. By using the determination process, it is possible to determine whether the illuminance sensor 102 is covered by a user's finger or the like.

A description will be given here by referring back to FIGS. 6A and 6B. The determining unit 123 determines, on the basis of the created determination information, whether the illuminance sensor 102 is covered (Step S7). If the illuminance sensor 102 is covered (Yes at Step S7), the determining unit 123 outputs, to the restricting unit 124, the restriction information that is used to restrict the automatic light control. If the restriction information that is used to restrict the automatic light control is input, the restricting unit 124 restricts, on the basis of the output values of the sensor output storing unit 111, the automatic light control of the display operation unit 101 (Step S8). If the automatic light control is restricted, the restricting unit 124 creates a record of the started up application in the startup app storing unit 112 and sets the flag to “1” (Step S9).

If the restricting unit 124 sets the flag associated with the application started up by the startup app storing unit 112 to “1”, the restricting unit 124 determines whether the started up application has been ended (Step S10). If the started up application has not been ended (No at Step S10), the restricting unit 124 repeats the end determination performed at Step S10. If the started up application has been ended (Yes at Step S10), the restricting unit 124 releases the restriction of the automatic light control (Step S11) and ends the process.

A description will be given here by referring back to Step S7. If the illuminance sensor 102 is not covered (No at Step S7), the determining unit 123 determines whether a record of the started up application that has been created in the startup app storing unit 112 is created (Step S12). If the record of the started up application has not been created (No at Step S12), the determining unit 123 creates the record of the started up application, sets the flag to “0” (Step S13), and proceeds to Step S14.

If the determining unit 123 creates a record of the started up application (Yes at Step S12), the determining unit 123 determines whether the started up application has been ended (Step S14). If the started up application has not been ended (No at Step S14), the determining unit 123 sets the flag associated with the started up application in the startup app storing unit 112 to “0” (Step S15) and returns to Step S5. If the started up application has been ended (Yes at Step S14), the determining unit 123 ends the process.

A description will be given here by referring back to Step S2. If the started up application is not the initial startup (No at Step S2), the determining unit 123 checks the flag that is associated with the started up application in the startup app storing unit 112 (Step S16). The determining unit 123 determines whether the flag that is associated with the started up application in the startup app storing unit 112 is “1” (Step S17). If the flag that is associated with the started up application in the startup app storing unit 112 is “1” (Yes at Step S17), the determining unit 123 stores the output value of the illuminance sensor 102 in the sensor output storing unit 111 (Step S18) and outputs the restriction information indicating that the automatic light control is restricted to the restricting unit 124. If the restriction information indicating that the automatic light control is restricted is input to the restricting unit 124, the restricting unit 124 restricts, on the basis of the output value of the sensor output storing unit 111, the automatic light control of the display operation unit 101 (Step S19) and proceeds to Step S10. If the flag that is associated with the started up application in the startup app storing unit 112 is not “1” (No at Step S17), the determining unit 123 determines that the subject application is an application that does not restrict the automatic light control and ends the process. By doing so, if the illuminance sensor 102 is covered by a user's finger or the like, the mobile terminal device 100 can constantly maintain the luminance of the display operation unit 101 and prevent the displayed screen from flickering.

As described above, the mobile terminal device 100 detects an input to a predetermined area that is set in the display operation unit 101 that includes a touch panel and determines whether the illuminance sensor 102 is affected by the input to the predetermined area. Furthermore, if the mobile terminal device 100 determines that the illuminance sensor 102 is affected, the mobile terminal device 100 restricts the automatic light control of the display operation unit 101. Consequently, it is possible to prevent the screen from flickering due to the effect of a user's hand.

Furthermore, the mobile terminal device 100 further detects the direction of the mobile terminal device 100 on the basis of the information from the acceleration sensor and detects an input to a predetermined area on the basis of the direction of the mobile terminal device 100. Consequently, for the area that is highly likely to be covered by a user's hand, it is determined whether the illuminance sensor 102 is affected; therefore, the processing amount can be reduced.

Furthermore, the mobile terminal device 100 samples output values of the illuminance sensor 102 at predetermined time intervals. Consequently, a variation in illuminance can be detected.

Furthermore, in addition to the detection of an input to the predetermined area, if there is a case in which one of the output values of the illuminance sensor sampled at the predetermined time intervals is less than the output value of the illuminance sensor at the immediately previous sampling timing, the mobile terminal device 100 determines that the illuminance sensor is affected. Consequently, the mobile terminal device 100 can detect a state in which the illuminance is decreased.

Furthermore, as the automatic light control of the display operation unit 101, the mobile terminal device 100 restricts the automatic light control of the display operation unit 101 so as to maintain the luminance of the display operation unit 101 on the basis of the output value of the illuminance sensor 102 when an application is started up. Consequently, it is possible to constantly maintain the luminance of the display operation unit 101 that is obtained when an application is started up during the application being running.

Furthermore, the mobile terminal device 100 restricts the automatic light control of the display operation unit 101 so as to maintain the luminance of the display operation unit 101 on the basis of the output value of the illuminance sensor 102 that is obtained when an application is started up. Furthermore, the mobile terminal device 100 releases the restriction of the automatic light control of the display operation unit 101 when the started up application has been ended or enters a background state in which data is not displayed on the display operation unit 101. Consequently, when the application in which the automatic light control is restricted has been ended or the state enters the background state, the automatic light control can be performed without any restriction.

Furthermore, if the application to be started up is the application in which the automatic light control of the display operation unit 101 is restricted at the time of start up of the application in the past, the mobile terminal device 100 does not detect an input of a user and does not determine whether the illuminance sensor is covered. Furthermore, the mobile terminal device 100 restricts the automatic light control of the display operation unit 101 so as to maintain the luminance of the display operation unit 101 on the basis of the output value of the illuminance sensor 102 that is obtained when the subject application is started up. Consequently, for the application in which the automatic light control is restricted in the past, it is possible to easily restrict the automatic light control.

Furthermore, in the first embodiment described above, the luminance fixed flag in the startup app storing unit 112 is set when the restriction of the automatic light control of the display operation unit 101 is started; however, the setting is not limited to this. For example, the luminance fixed flag in the startup app storing unit 112 may also be set when the restriction of the automatic light control of the display operation unit 101 is released.

As described above, when the mobile terminal device 100 releases the restriction of the automatic light control of the display operation unit 101 is released, the mobile terminal device 100 associates the started up application with the luminance fixed flag that indicates that the automatic light control is restricted and then stores the associated data in the startup app storing unit 112. Consequently, when the application is ended abnormally or the like, it is possible to perform the determination process again and determine whether the illuminance sensor 102 is likely to be covered.

Furthermore, in the first embodiment described above, it is determined whether the illuminance sensor 102 is covered for each application; however, the determination may also be performed including a standby screen or the like. This case will be described below as a second embodiment.

### [b] Second Embodiment

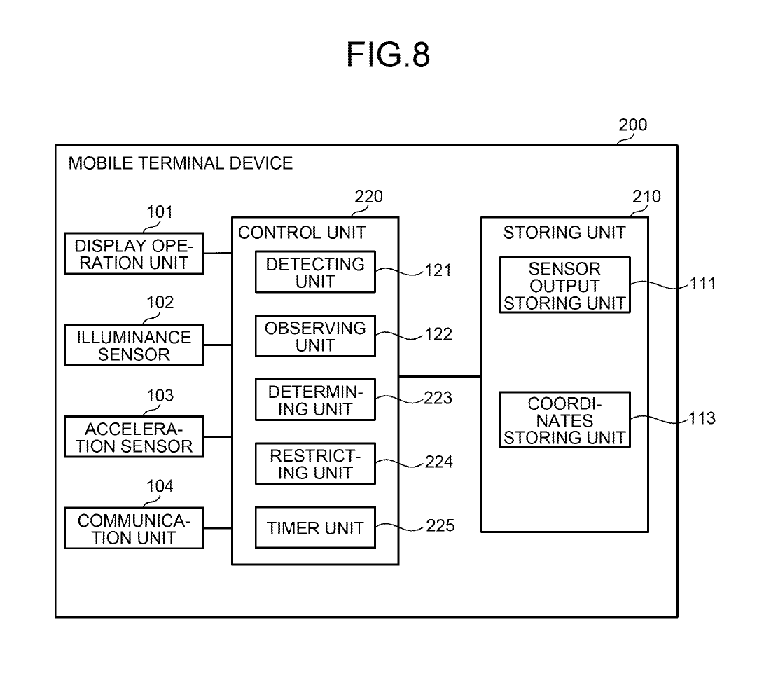

FIG. 8 is a block diagram illustrating an example of the configuration of a mobile terminal device according to a second embodiment. The components having the same configuration as those in the mobile terminal device 100 described in the first embodiment are assigned the same reference numerals; therefore, descriptions of the configuration and the operation thereof will be omitted. A mobile terminal device 200 according to the second embodiment differs from the mobile terminal device 100 according to the first embodiment in that, when an input is performed in the display operation unit 101 by a user, the automatic light control of the display operation unit 101 is restricted for a predetermined time period.

When compared with the mobile terminal device 100 according to the first embodiment, the mobile terminal device 200 according to the second embodiment includes, instead of the determining unit 123 and the restricting unit 124, a determining unit 223 and a restricting unit 224 in a control unit 220 and further includes a timer unit 225. Furthermore, when compared with the mobile terminal device 100 according to the first embodiment, with the mobile terminal device 200 according to the second embodiment, a storing unit 210 need not include the startup app storing unit 112.

When restriction information is input from the restricting unit 224, the determining unit 223 determines whether one or more coordinate values in the coordinates storing unit 113 stored by the detecting unit 121 is located in a predetermined area that is input by the observing unit 122. If one or more coordinate values in the coordinates storing unit 113 is located in the predetermined area, the determining unit 223 determines whether there may be a case in which the output value of the coordinates storing unit 113 is less than the output value at the immediately previous sampling timing. If the output value of the coordinates storing unit 113 is less than the output value at the immediately previous sampling timing, the determining unit 223 creates determination information indicating that the illuminance sensor 102 is covered. If none of the coordinate values of the coordinates storing unit 113 is located in the subject predetermined area and if the output value of the coordinates storing unit 113 is equal to or greater than the output value at the immediately previous sampling timing, the determining unit 223 creates determination information indicating that the illuminance sensor 102 is not covered.

If the determining unit 223 creates the determination information indicating that the illuminance sensor 102 is covered, the determining unit 223 outputs timer information to the timer unit 225. If the determining unit 223 creates the determination information indicating that the illuminance sensor 102 is not covered, the determining unit 223 outputs release information indicating that the automatic light control is to be released to the restricting unit 224. Furthermore, for the case in which clear information is input from the timer unit 225, the determining unit 223 also performs the same process as that performed when the restriction information is input from the restricting unit 224.

When a predetermined area is input from the observing unit 122, the restricting unit 224 refers to the coordinates storing unit 113 and determines whether an operation is input by a user to the display operation unit 101. If no operation is input to the display operation unit 101, the restricting unit 224 waits for an operation to be input to the display operation unit 101. If an operation is input to the display operation unit 101, the restricting unit 224 instructs the detecting unit 121 to store the output value of the illuminance sensor 102 in the sensor output storing unit 111.

The restricting unit 224 restricts the automatic light control of the display operation unit 101 on the basis of the output value of the sensor output storing unit 111. Namely, the restricting unit 224 restricts the automatic light control of the display operation unit 101 so as to maintain the luminance of the display operation unit 101 on the basis of the output value of the illuminance sensor 102 obtained when a user touched the display operation unit 101. When the restricting unit 224 restricts the automatic light control, the restricting unit 224 outputs restriction information to the determining unit 223. Furthermore, when the restricting unit 224 receives an input of the release information from the determining unit 223 or the timer unit 225, the restricting unit 224 releases the restriction of the automatic light control.

If timer information is input from the determining unit 223, the timer unit 225 starts the timer in which a predetermined time period is set. Here, an arbitrary time period, such as 10 seconds, 30 seconds, or the like, may be set for the predetermined time period. The timer unit 225 refers to the coordinates storing unit 113 and determines whether an operation is input to the display operation unit 101 by a user. If an operation is input to the display operation unit 101, the timer unit 225 clears the timer, i.e., resets the timer, and then outputs clear information to the determining unit 223.

If no operation is input to the display operation unit 101, the timer unit 225 determines whether the timer has expired. If the timer has not expired, the timer unit 225 repeatedly determines whether an operation is input to the display operation unit 101. If the timer has expired, the timer unit 225 outputs, to the restricting unit 224, release information indicating that the restriction of the automatic light control is released.

In the following, a description will be given of the operation of the mobile terminal device 200 according to the second embodiment. The determination process from among the processes performed by the mobile terminal device 200 according to the second embodiment is the same as that performed by the mobile terminal device 100 according to the first embodiment; therefore, a description thereof will be omitted.

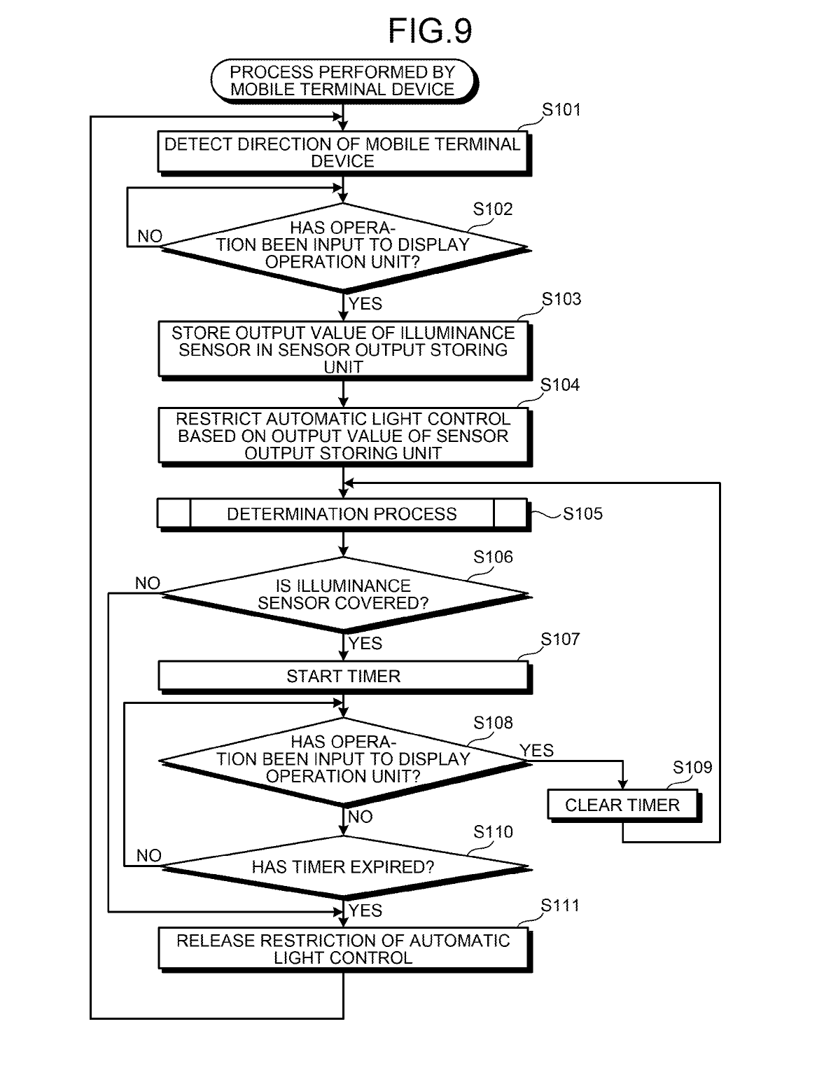

FIG. 9 is a flowchart illustrating an example of the flow of a process performed by the mobile terminal device according to the second embodiment. The observing unit 122 in the mobile terminal device 200 observes the direction of the mobile terminal device 200 on the basis of the acceleration information (Step S101). The observing unit 122 sets a predetermined area in accordance with the direction of the mobile terminal device 200 and outputs the set predetermined area to the restricting unit 224. If the predetermined area is input from the observing unit 122, the restricting unit 224 refers to the coordinates storing unit 113 and determines whether an operation is input to the display operation unit 101 by a user (Step S102). If no operation is input to the display operation unit 101 (No at Step S102), the restricting unit 224 repeats the determination and waits for an operation to be input to the display operation unit 101.

If an operation is input to the display operation unit 101 (Yes at Step S102), the restricting unit 224 instructs the detecting unit 121 to store the output value of the illuminance sensor 102 in the sensor output storing unit 111. The detecting unit 121 stores the output value of the illuminance sensor 102 at the timing instructed by the restricting unit 224 in the sensor output storing unit 111 (Step S103). The restricting unit 224 restricts the automatic light control of the display operation unit 101 on the basis of the output value of the sensor output storing unit 111 (Step S104). When the restricting unit 224 restricts the automatic light control, the restricting unit 224 outputs the restriction information to the determining unit 223.

When the restriction information is input from the restricting unit 224, the determining unit 223 performs the determination process (Step S105). The determining unit 223 determines, on the basis of the created determination information, whether the illuminance sensor 102 is covered (Step S106). If the illuminance sensor 102 is covered (Yes at Step S106), the determining unit 223 outputs the timer information to the timer unit 225.

If the timer information is input to the determining unit 223, the timer unit 225 starts the timer that is set at a predetermined time period (Step S107). The timer unit 225 refers to the coordinates storing unit 113 and determines whether an operation is input to the display operation unit 101 by a user (Step S108). If an operation is input to the display operation unit 101 (Yes at Step S108), the timer unit 225 clears the timer (Step S109), outputs the clear information to the determining unit 223, and returns to the process at Step S105.

If no operation is input to the display operation unit 101 (No at Step S108), the timer unit 225 determines whether the timer has expired (Step S110). If the timer has not expired (No at Step S110), the timer unit 225 returns to the process at Step S108. If the timer has expired (Yes at Step S110), the timer unit 225 outputs, to the restricting unit 224, the release information indicating that the restriction of the automatic light control is released. If the release information is input from the timer unit 225, the restricting unit 224 releases the restriction of the automatic light control (Step S111).

A description will be given here by referring back to Step S106. If the illuminance sensor 102 is not covered (No at Step S106), the determining unit 223 outputs, to the restricting unit 224, the release information indicating that the automatic light control is released. If the release information is input from the determining unit 223, the restricting unit 224 releases the automatic light control (Step S111). By doing so, even if the state is in a standby state in which no application is started up, when the illuminance sensor 102 is covered by a user's finger, the mobile terminal device 200 can constantly maintain the luminance of the display operation unit 101 and suppress the displayed screen from flickering.

As described above, the mobile terminal device 200 detects an input to a predetermined area that is set in the display operation unit 101 that includes a touch panel; restricts, when an input to the predetermined area has been detected, the automatic light control of the display operation unit 101; and determines whether the illuminance sensor 102 is affected by an input to the predetermined area. Furthermore, if the mobile terminal device 200 determines that the illuminance sensor 102 is affected, the mobile terminal device 200 starts the timer that is set to a predetermined time period for restricting the automatic light control of the display operation unit 101. Furthermore, if a new input to the display operation unit 101 is not detected in the predetermined time period, the mobile terminal device 200 releases the restriction of the automatic light control of the display operation unit 101. Consequently, it is possible to maintain the luminance of the display operation unit 101 to the luminance obtained when a user touched the displayed screen that is in a standby state and suppress the displayed screen from flickering.

Furthermore, as the automatic light control of the display operation unit 101, the mobile terminal device 200 restricts the automatic light control of the display operation unit 101 so as to maintain the luminance of the display operation unit 101 on the basis of the output value of the illuminance sensor 102 obtained when an input is performed on the display operation unit 101. Consequently, it is possible to constantly maintain, for a predetermined time period, the luminance of the display operation unit 101 obtained when a user starts an operation of the mobile terminal device 200.

The components of each unit illustrated in the drawings are not always physically configured as illustrated in the drawings. In other words, the specific shape of a separate or integrated unit is not limited to the drawings; however, all or part of the unit can be configured by functionally or physically separating or integrating any of the units depending on various loads or use conditions. For example, the detecting unit 121 and the observing unit 122 may also be integrated as a single unit.

Furthermore, all or any part of the processing functions performed by each unit may also be executed by a CPU or a microcomputer, such as an MPU, a micro controller unit (MCU), or the like. Furthermore, all or any part of the processing functions may also be executed by programs analyzed and executed by the CPU or the microcomputer, such as the MPU or the MCU, or executed by hardware by wired logic.

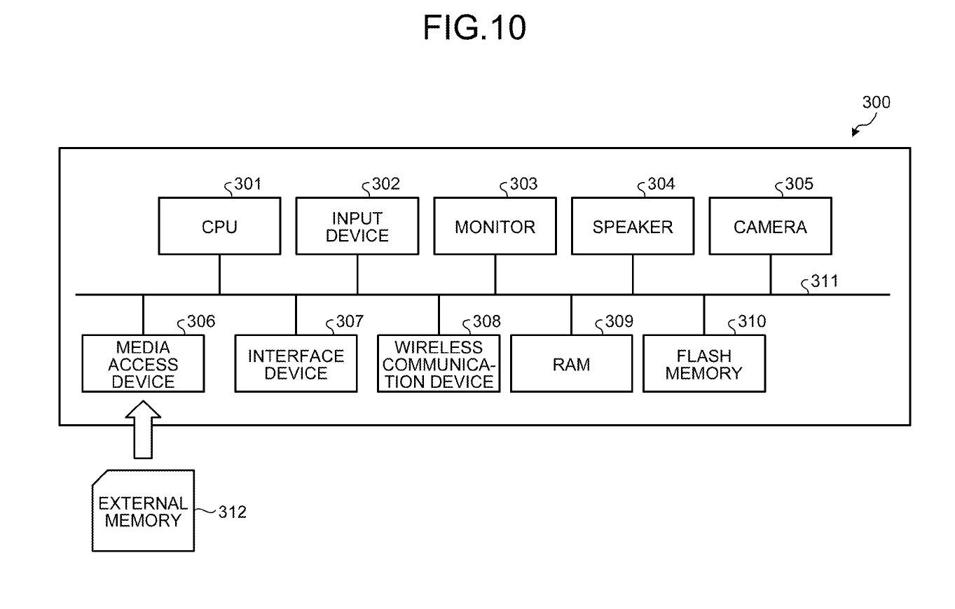

Various kinds of processes described in the above embodiments can be implemented by programs prepared in advance and executed by a computer. Accordingly, in the following, a computer that executes programs having the same function as that described in the embodiment described above will be described as an example. FIG. 10 is a block diagram illustrating an example of a computer that executes a display control program.

As illustrated in FIG. 10, a computer 300 includes a CPU 301 that executes various kinds of arithmetic processing, an input device 302 that receives an input of data from a user, a monitor 303, and a speaker 304 that outputs audio. Furthermore, the computer 300 includes a camera 305 that captures an image and a media access device 306 that reads a program or the like from a storage medium and that writs data or the like to the storage medium. Furthermore, the computer 300 includes an interface device 307 that is used to connect the illuminance sensor and the acceleration sensor and includes a wireless communication device 308 that is used to wirelessly connect to the other device. Furthermore, the computer 300 includes a RAM 309 and a flash memory 310 that temporarily store therein various kinds of information. Furthermore, each of the devices 301 to 310 is connected to a bus 311.

The flash memory 310 stores therein a display control program that has the same function as that performed by each of the processing units, such as the detecting unit 121, the observing unit 122, the determining unit 123 or 223, the restricting unit 124 or 224, and the timer unit 225 described in the embodiments. Furthermore, the flash memory 310 stores therein various kinds of data for implementing the sensor output storing unit 111, the startup app storing unit 112, the coordinates storing unit 113, and the display control program. Furthermore, the medium access device 306 reads and writes various applications or data from and to an external memory 312.

The CPU 301 reads each of the programs stored in the flash memory 310, loads the programs in the RAM 309, thereby performing various processes. Furthermore, these programs allow the computer 300 to function as the detecting unit 121, the observing unit 122, the determining unit 123 or 223, the restricting unit 124 or 224, and the timer unit 225 described in the embodiments.

The display control program described above is not always stored in the flash memory 310. For example, the computer 300 may also read and execute the program stored in a storage medium that can be read by the computer 300. Examples of the computer 300 readable storage medium include a portable recording medium, such as a CD-ROM, a DVD disk, a universal serial bus (USB) memory, or the like, a semiconductor memory, such as a flash memory or the like, and a hard disk drive. Furthermore, the display control program may also be stored in a device connected to, for example, a public circuit, the Internet, a local area network (LAN), a wide area network (WAN), or the like and the computer 300 may also read and execute the display control program described above.

According to an aspect of an embodiment of the present invention, an advantage is provided in that it is possible to suppress a screen from flickering affected by a user's hand.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile terminal device comprising:
a detecting unit that detects an input to a predetermined area that is set in a display operation unit that includes a touch panel;
a determining unit that determines whether an illuminance sensor is affected by the input to the predetermined area; and
a restricting unit that restricts automatic light control of the display operation unit when the determining unit determines that the illuminance sensor is affected.

2. The mobile terminal device according to claim 1, further comprising an observing unit that observes a direction of the mobile terminal device on the basis of information from an acceleration sensor, wherein
the detecting unit detects the input to the predetermined area on the basis of the direction of the mobile terminal device.

3. The mobile terminal device according to claim 1, wherein the detecting unit samples an output value of the illuminance sensor at predetermined time intervals.

4. The mobile terminal device according to claim 3, wherein, in addition to the detection of the input to the predetermined area by the detecting unit, when the output value of the illuminance sensor sampled at the predetermined time intervals is less than an output value of the illuminance sensor that is obtained at an immediately previous sampling timing, the determining unit determines that the illuminance sensor is affected.

5. The mobile terminal device according to claim 1, wherein the restricting unit restricts the automatic light control of the display operation unit so as to maintain luminance of the display operation unit on the basis of an output value of the illuminance sensor obtained when an application is started up or when an input to the display operation unit is performed.

6. The mobile terminal device according to claim 1, wherein the restricting unit releases the restriction of the automatic light control of the display operation unit when the automatic light control of the display operation unit is restricted so as to maintain the luminance of the display operation unit on the basis of the output value of the illuminance sensor at starting up of an application and when the started up application has been ended or enters a background state in which a display is not performed onto the display operation unit.

7. The mobile terminal device according to claim 6, wherein, when the restricting unit releases the restriction of the automatic light control of the display operation unit, the restricting unit stores, in an associated manner in a storing unit, the started up application and a luminance fixed flag that indicates that the restriction of the automatic light control has been performed.

8. The mobile terminal device according to claim 1, wherein, when an application to be started up is an application in which the automatic light control of the display operation unit is restricted at the time of starting up in the past, the restricting unit restricts the automatic light control of the display operation unit so as to maintain the luminance of the display operation unit on the basis of the output value of the illuminance sensor at the time of the starting up of the application without detecting the input of the detecting unit and without performing the determination by the determining unit.

9. A display control method comprising:
detecting, performed by a computer, an input to a predetermined area that is set in a display operation unit that includes a touch panel;
determining, performed by the computer, whether an illuminance sensor is affected by the input to the predetermined area; and
restricting, performed by the computer, when it is determined at the determining that the illuminance sensor is affected, automatic light control of the display operation unit.

10. A non-transitory computer-readable recording medium having stored therein a display control program that causes a computer to execute a process comprising:
detecting an input to a predetermined area that is set in a display operation unit that includes a touch panel;
determining whether an illuminance sensor is affected by the input to the predetermined area; and
restricting, when it is determined at the determining that the illuminance sensor is affected, automatic light control of the display operation unit.
